(19) United States
(12) Patent Application Publication
(10) Pub. No.: US 2026/0185569 A1
(43) Pub. Date: Jul. 2, 2026

(54) FREEWHEEL DEVICE FOR AN ELECTRIC DRIVE OF A VEHICLE, AND ELECTRIC DRIVE FOR THE VEHICLE

(71) Applicant: Schaeffler Technologies AG & Co. KG, Herzogenaurach (DE)

(72) Inventor: Alexander Reimchen, Herzogenaurach (DE)

(73) Assignee: Schaeffler Technologies AG & Co. KG, Herzogenaurach (DE)

(21) Appl. No.: 18/860,164

(22) PCT Filed: Mar. 23, 2023
(86) PCT No.: PCT/DE2023/100228

§ 371 Date: Oct. 25, 2024

(30) Foreign Application Priority Data
Apr. 28, 2022 (DE) 10 2022 110 294.7

(51) Int. Cl. F16D 41/24; B62M 6/60

(52) U.S. Cl. CPC F16D 41/24; B62M 6/60

(57) ABSTRACT

A freewheel device for a vehicle electric drive includes a housing, a first disc arranged rotatably in the housing, a second disc arranged rotationally fixed in the housing, and a spring member arranged to axially bias the second disc against the first disc. The first disc has a plurality of form-fit receptacles and the second disc has a plurality of rigid form-fit members arranged to engage the form-fit receptacles. The form-fit members and the form-fit receptacles are in a blocking state in a blocking direction, and the form-fit members and the form-fit receptacles are in a freewheel state in a freewheel direction, opposite the blocking direction.

### CROSS-REFERENCE TO RELATED APPLICATIONS

This application is the United States National Phase of PCT Appln. No. PCT/DE2023/100228 filed Mar. 23, 2023, which claims priority to German Application No. DE102022110294.7 filed Apr. 28, 2022, the entire disclosures of which are incorporated by reference herein.

### TECHNICAL FIELD

The present disclosure relates to a freewheel device for an electric drive of a vehicle and an electric drive having the freewheel device.

### BACKGROUND

Freewheels are often used in transmissions and serve, for example, as an overrunning clutch when two driven shafts are transmittingly coupled to one another. The freewheels perform an overrunning function when the first of the two shafts rotates faster than the second shaft, or a decoupling function when, for example, the second shaft is stationary and only the first shaft rotates.

An example of a corresponding freewheel is shown in document U.S. Pat. No. 7,296,668 B2. This document discloses a freewheel which has a first ring with ramps and a second ring running thereon, wherein blocking bodies are arranged on the second ring and are biased with springs relative to the first ring.

### SUMMARY

The present disclosure provides a freewheel device for an electric drive which can be produced in a cost-effective manner. Example embodiments are derived from the following description and the attached figures.

The disclosure relates to a freewheel device, which is, for example, suitable and/or designed for an electric drive of a vehicle. The vehicle may be designed as a muscle-powered vehicle and/or as a muscle-powered bicycle, for example. The electric drive may be designed as a hub drive on the bicycle and serves to support the rider.

The freewheel device has a first disc, wherein the first disc has a plurality of form-fit receptacles. The form-fit receptacles may be formed as through-openings. In alternative embodiments, the form-fit receptacles can also be realized as recesses. The form-fit receptacles may be arranged on a common pitch circle around a main axis of rotation of the freewheel device, e.g., in a regularly distributed manner.

Furthermore, the freewheel device has a second disc. According to the disclosure, the second disc has a plurality of rigid, e.g., immovable and/or unsprung, form-fit members. The form-fit members may be arranged on a common pitch circle around a main axis of rotation of the freewheel device, e.g., a regularly distributed manner. The form-fit members can engage in the form-fit receptacles.

The first and second disc can be rotated relative to one another in a circumferential direction about the main axis of rotation. When the second disc overruns and/or drives the first disc in a blocking direction, the freewheel device is in a blocking state and the second disc presses with the blocking members in a blocking direction against the form-fit receptacles. When the second disc falls back relative to the first disc in the circumferential direction, the freewheel device is in a freewheel state and the second disc moves with the blocking members in a freewheel direction against the form-fit receptacles.

Thus, the freewheel device can perform an overrunning function and/or a decoupling function when the first disc rotates faster than the second disc or when the first disc rotates and the second disc is stationary.

The freewheel device has a housing and a spring device, wherein one of the discs is arranged in a rotationally fixed manner and the other disc is rotatably arranged, e.g., rotatably about the main axis of rotation, in the housing. The spring device biases the rotationally fixed disc in the axial direction against the rotatable disc. The rotationally fixed disc may, in its entirety, be displaced by the spring device. The rotationally fixed disc is arranged to be displaceable in the axial direction in the housing.

The spring device is designed, for example, as a compression spring which acts between the rotationally fixed disc and the housing. For example, the spring device can be configured as a disc spring. The spring device can be designed as a one-piece spring device. Alternatively, it can be formed from individual springs. Alternatively, the spring device can be designed as a tension spring, the tension spring biasing the rotationally fixed disc against the rotationally fixed disc.

It is a consideration of the disclosure that the blocking bodies in the prior art are each individually spring-loaded and thus also individually engage in the ramp contour. In contrast, the disclosed device proposes that the form-fit members are designed to be rigid, e.g., immovable, on the second disc and that the spring device can bias, e.g., displace, the rotationally fixed disc in its entirety in the axial direction, so that a plurality of movably mounted, individual blocking bodies can be dispensed with. Instead, the rotationally fixed disc is biased in its entirety, which saves costs due to the reduction in parts and offers simplified installation of the freewheel device.

In an example embodiment, the arrangement of the housing, the first disc, the second disc and the spring device is designed as a structural unit. The first disc has form-fit recesses (ramp structure) as form-fit receptacles, which can optionally also be provided directly with a hub for a shaft-hub connection. It can therefore be rotated relative to the housing. The second disc is provided with projections or counter-ramps as form-fit members, which correspond in a form-fitting manner to the form-fit recesses. The second disc is connected to the housing in a torque-resistant but axially displaceable manner. The housing is optionally associated in a rotationally fixed manner with a casing, another shaft, etc. The spring(s) as a spring device is/are axially supported against the housing and biased against the first disc.

In an example embodiment, the form-fit members are formed integrally in the second disc. For example, the form-fit members are made integrally from a common base material of the second disc and/or from one material, e.g., as formed sections. This structural development ensures that a large number of form-fit members do not have to be manufactured or be subsequently mounted on the second disc. Instead, the form-fit members are manufactured integrally with the second disc. This structural design saves further costs with regard to the individual parts and leads to further benefits during installation of the freewheel device.

In an example embodiment, the second disc is designed as a shaped sheet-metal part. Alternatively or additionally, the form-fit members are designed as formed sections in the second disc, e.g., designed as the shaped sheet-metal part. In this way, the plurality of the form-fit members can be cost-effectively manufactured in their entirety at the same time in one single forming step and arranged on the second disc with high positional accuracy and low tolerances.

In an example embodiment, the form-fit members are each equipped with a blocking section in the blocking direction and the form-fit receptacles have a corresponding blocking contour. For example, the blocking section can be designed as a contact surface which runs perpendicular to a radial plane with respect to the main axis of rotation and which extends in the radial direction, and the form-fit receptacles as a blocking contour can have a blocking surface, running in the same plane, as a blocking contour. The blocking section bears form-fittingly in the blocking direction against the blocking contour so as to realize the blocking state.

Alternatively or additionally, the form-fit members each have a ramp section in the freewheel direction, which is designed to descend in the freewheel direction of the second disc. The form-fit receptacles each have a ramp contour which is designed to rise in the freewheel direction of the ramp section so that the ramp section can slide down and/or up on the ramp contour in the freewheel direction, and an axial distance between the first disc and the second disc is created and/or increased.

In an example embodiment, the rotatable disc is slidingly mounted in the housing. The slide bearing arrangement ensures that no additional parts are required, for example for a rolling bearing device. The rotatable disc may be slidingly mounted in the axial direction in the housing and/or on the housing. In the radial direction, the rotatable disc may be designed with the outer circumference spaced apart from the housing so that no friction occurs.

The rotatable disc may have a hub section for a shaft-hub connection. This hub section is designed for connection to a pedal crankshaft and/or to an output gear. This additional development also supports the aim of keeping the number of individual parts of the freewheel device low, thus keeping the freewheel device as a whole cost-effective and easy to assemble.

In a further embodiment, the housing has an external toothing system. For example, the external toothing system can be mounted on the housing. However, the external toothing system may be incorporated into the housing so that no additional parts are required and the cost-effective design is further developed.

In an example embodiment, the first disc is designed as a rotatable ramp disc and/or the second disc is designed as a rotationally fixed but axially displaceable pressure disc.

In an example embodiment, the freewheel device has a switching sleeve, with the switching sleeve being arranged coaxially with respect to the main axis of rotation. The switching sleeve is designed to displace the rotationally fixed disc in the axial direction, e.g., in such a way that the form-fit members are pulled out of the form-fit receptacles in the axial direction so that an engagement between the two discs is released. The switching sleeve makes it possible to realize a switchable freewheel device.

The present disclosure also relates to an electric drive for a vehicle. The electric drive has an electric motor to generate a drive torque, a transmission to convert the drive torque and a pedal crankshaft to introduce a pedal torque. The transmission is coupled to a drive gear for outputting the drive torque or the converted drive torque. The drive gear is arranged coaxially with respect to the pedal crankshaft and is transmittingly connected to the pedal crankshaft via the freewheel device, with the freewheel device being designed as previously described. In this embodiment, the vehicle can optionally be driven exclusively by muscle power, wherein the freewheel device performs a decoupling function in the freewheel state. It is also possible for the freewheel device to perform an overrunning function in the freewheel state if the speed of the pedal crankshaft rotates faster than the drive gear due to the introduced pedal torque. As long as the drive gear rotates faster or at the same speed as the pedal crankshaft, the freewheel device is in a blocking state and the converted drive torque is transmitted to the pedal crankshaft and/or to the output gear.

### BRIEF DESCRIPTION OF THE DRAWINGS

Further features, advantages and effects of the disclosure are derived from the following description of an exemplary embodiment and the attached figures. In the figures:

FIG. 1 shows a schematic, longitudinal sectional view of a freewheel device as an exemplary embodiment;

FIGS. 2a and 2b show a schematic, three-dimensional representation of the freewheel device in FIG. 1;

FIG. 3 shows a schematic plan view of a first disc of the freewheel device in the preceding figures;

FIGS. 4a and 4b show a schematic lateral view and an axial plan view of a second disc of the freewheel device from the preceding figures;

FIGS. 5a, 5b and 5c show a base part of a housing in a three-dimensional representation of the freewheel device from the previous figures;

FIGS. 6a and 6b each show a schematic, three-dimensional representation of the base part from FIGS. 5a, 5b and 5c together with the second disc of FIGS. 4a and 4b during assembly;

FIG. 7 shows a schematic longitudinal sectional view of the freewheel device from the preceding figures with a switching sleeve, in which the freewheel device is in a switched state;

FIG. 8 shows a schematic axial plan view and a sectional view along the section line X-X of the freewheel device in a switched state;

FIG. 9 shows a schematic longitudinal sectional view of the freewheel device from the preceding figures with a switching sleeve, wherein the freewheel device is in a decoupled state;

FIG. 10 shows a schematic axial plan view and a sectional view along the section line X-X of the freewheel device in the decoupled state; and

FIG. 11 shows a schematic block diagram of a vehicle with an electric drive which has the freewheel device from the preceding figures.

### DETAILED DESCRIPTION

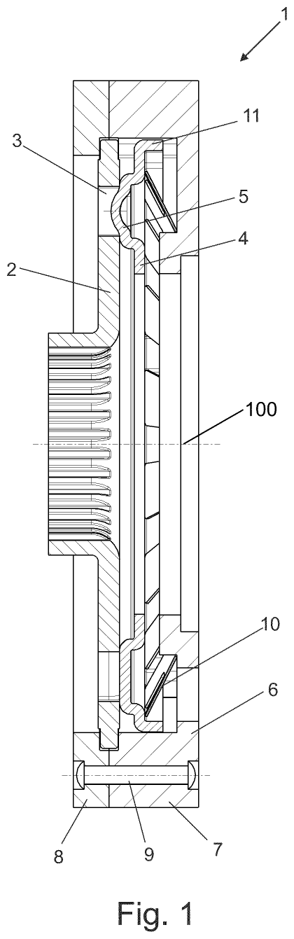

FIG. 1 shows a longitudinal section of a freewheel device 1 along a main axis of rotation 100 as an exemplary embodiment. The freewheel device 1 is suitable and/or designed for an electric drive of a vehicle. For example, the freewheel device 1 is used to transmittingly connect a muscle-powered drive from a rider of the vehicle to a drive from an electric motor of the electric drive.

The freewheel device 1 has a first disc 2, wherein the first disc 2 is designed as a ramp disc. The first disc 2 has a plurality of form-fit receptacles 3, which are designed as through-openings and extend continuously in the same direction as the main axis of rotation 100.

The freewheel device 1 has a second disc 4, in which the second disc 4 is arranged coaxially with respect to the first disc 2 and is designed as a pressure disc. The second disc 4 has a plurality of form-fit members 5 which engage in the form-fit receptacles 3 in the shown operating state of the freewheel device 1. The form-fit members 5 are arranged so as to project from the second disc 4.

The first disc 2 and the second disc 4 are accommodated and/or arranged in a housing 6, wherein the housing 6 is formed in two parts. The housing 6 has a base part 7 and a cover part 8. The base part 7 and the cover part 8 are connected to one another via fastening means 9, in this exemplary embodiment a plurality of rivets.

The freewheel device 1 has a spring device 10, wherein the spring device 10 in this exemplary embodiment is designed as a circumferential disc spring. The spring device 10 is supported on the one hand on the housing 6 and, viewed more closely, on the base part 7. Furthermore, the spring device 10 is supported on the second disc 4 such that it is biased in the axial direction to the main axis of rotation 100 in the direction of the first disc 2.

The second disc 4 is arranged in the housing 6 so as to be axially displaceable with respect to the main axis of rotation 100. In order to prevent the second disc 4 from tilting, the second disc 4 has a circumferential guide collar 11, and the guide collar 11 is supported circumferentially on the housing 6, in this case on the base part 7, such that the second disc 4 is supported and/or guided in the radial direction.

However, the second disc 4—as can be seen in particular from the following figures—is arranged in a rotationally fixed manner in the housing 6, in this case in the base part 7.

Conversely, the first disc 2 is supported in a rotatable manner in the housing 6. However, the first disc 2 is only positioned in a slidingly mounted manner in the housing 6. In the axial direction, the first disc 2 is slidingly mounted on both sides of the housing 6. In particular, the cover part 8 forms a first slide bearing arrangement with the first disc 2 and the base part 7 forms a second slide bearing with the first disc 2.

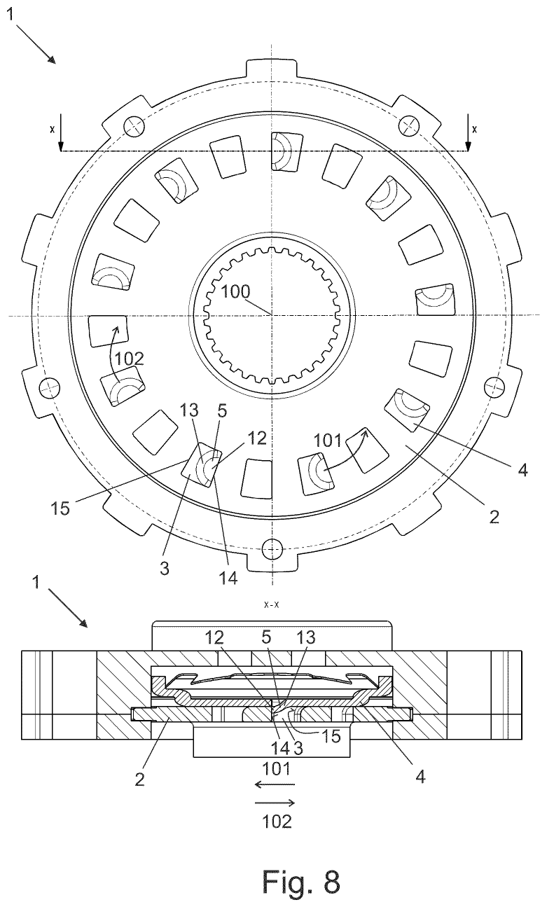

To explain the function of the freewheel device 1, reference is made to FIG. 8. For orientation purposes, this shows an axial plan view of the freewheel device 1 and a sectional view along the section line X-X. In the sectional view, it can be seen that the form-fit members 5 each have a blocking section 12 and a ramp section 13. The form-fit receptacles 3 each have a blocking contour 14 and a ramp contour 15. The blocking section 12 has a blocking surface which lies in a plane in which the main axis of rotation 100 also lies and which extends radially to the main axis of rotation 100. The blocking contour 14, on the other hand, has a counter-blocking surface which lies in the same plane, namely in the plane of the main axis of rotation 100 and at the same time radially with respect to the main axis of rotation 100. When the second disc 4 moves relative to the first disc 2 in a blocking direction 101, the blocking surface of the blocking section 12 bears form-fittingly against the counter-locking surface of the blocking contour 14 so as to create a form-fitting connection in the circumferential direction.

The ramp section 13 is designed to slope downwards in a freewheel direction 102, whereas the ramp contour 15 is designed to slope upwards in the freewheel direction 102, such that when the second disc 4 rotates relative to the first disc 2, the ramp section 13 slides over the ramp contour 15, while at the same time an axial distance between the second disc 4 and the first disc 2 is increased against the spring force of the spring device 10 so that the freewheel device 1 is in a freewheel state.

From the axial plan view it can be seen that the ramp section has a semicircular contour in the freewheel direction 102 so as to simplify ramp engagement.

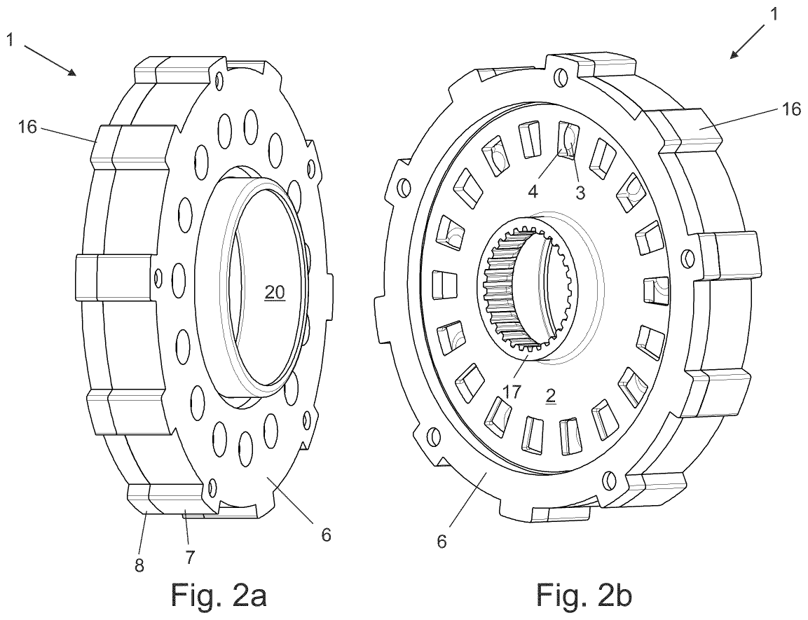

FIGS. 2a and 2b each show the freewheel device 1 in a schematic three-dimensional representation. The representation again shows the engagement of the freewheel members 5 in the freewheel receptacles 3, which are designed as windows. Furthermore, it can be seen that the housing 6 has a plurality of projections 16 on the outer circumference so that the housing 6 can be fitted in a form-fitting manner in the circumferential direction into a receiving structure. Alternatively, the housing 6 can also support or form an external toothing system.

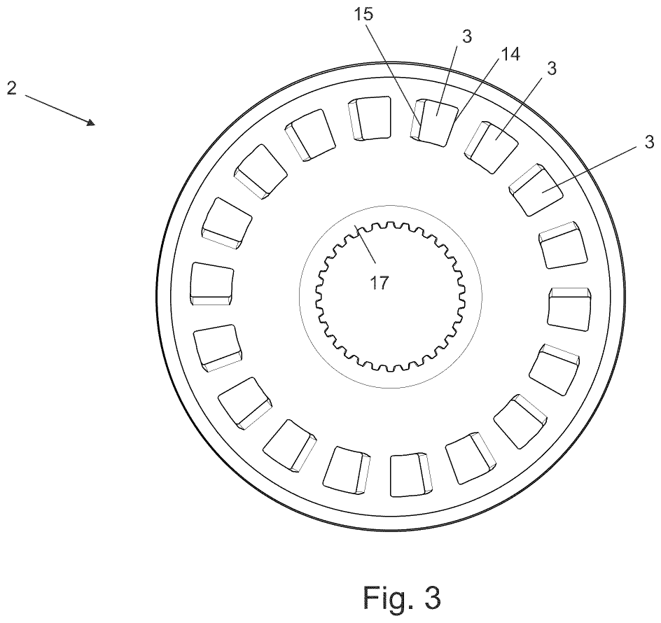

FIG. 3 shows an axial plan view of the first disc 2, in which the blocking contours 14 can be seen in the form-fit receptacles 3 and the ramp contours 15 opposite. The first disc 2 has an integrated hub section 17, which has a spline on the inner circumference for coupling to a pedal crankshaft. The second disc 2 is designed, for example, as a solid component, or alternatively it is realized as a formed component which has been subsequently machined.

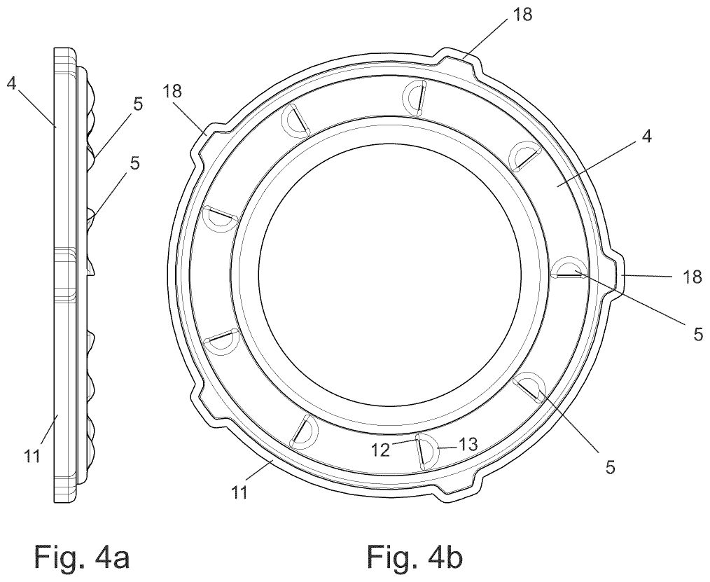

FIG. 4a and FIG. 4b show a lateral plan view and an axial plan view of the second disc 4, respectively, in which the protruding and/or projecting form-fit members 5 can be clearly seen. Furthermore, it can be seen that the second disc 4 has axially extending projection contours 18, which allows a rotationally fixed arrangement of the second disc 4 in the housing 6, in particular in the base part 7. From this representation it can be seen in particular that the second disc 4 is designed as a shaped sheet-metal part and the form-fit members 5, the guide collar 11 and the projection contours 18 are formed from a base material of the second disc 4 by forming. This means that the second disc 4 can be produced cost-effectively.

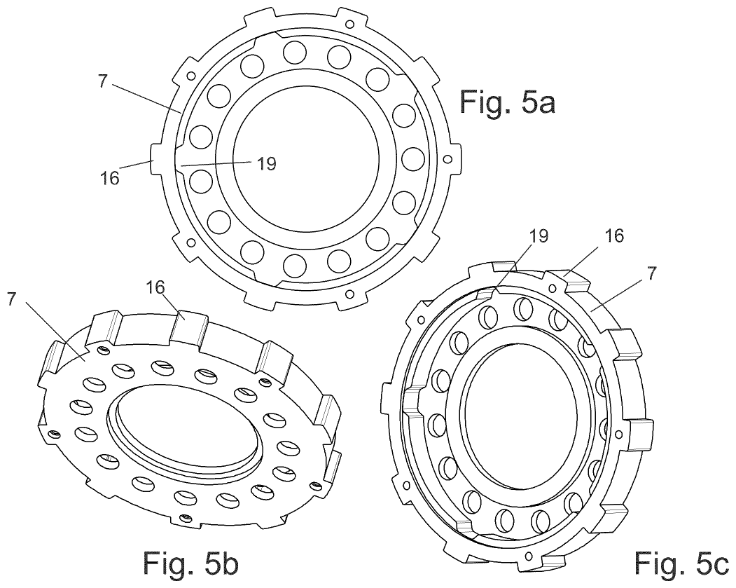

FIGS. 5a, 5b and 5c show different views of the base part 7 of the housing 6. In this representation it can be seen in particular that projection receptacles 19 are provided for receiving the projection contours 18 so that the second disc 4 can be received in the housing 6, in particular in the base part 7, in a rotationally fixed but axially displaceable manner. Furthermore, openings have been made that can be used for oil lubrication.

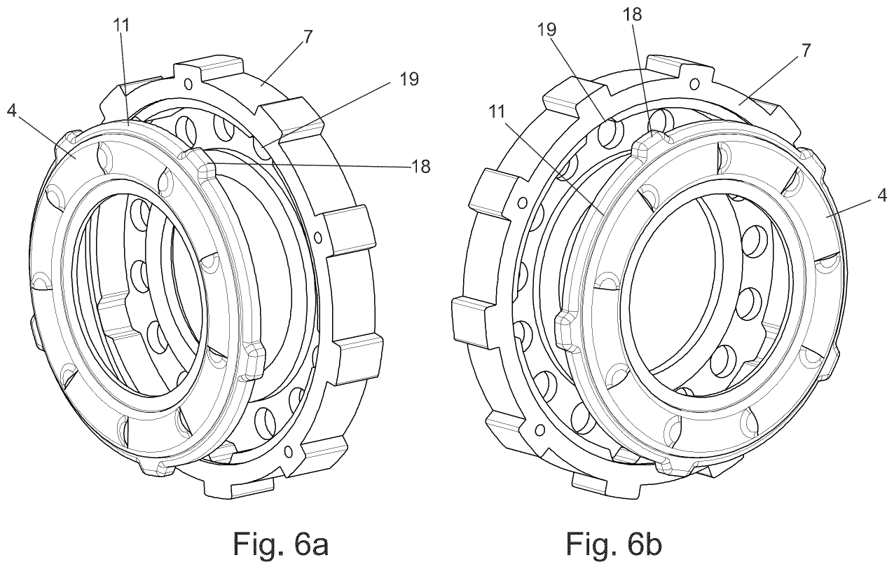

The installation of the second disc 4 in the housing 6 or in the base part 7 is shown in FIGS. 6a and 6b, in which it can be seen that the projection contours 18 move into the projection receptacles 19 in the axial direction. Furthermore, the guide collar 11 can also be seen, with the guide collar 11 forming a circumferential contact surface for the axial guidance of the second disc 4 in the housing 6.

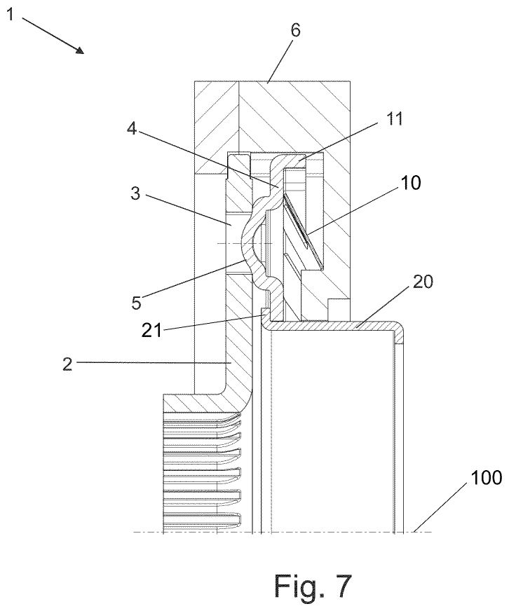

FIG. 7 shows a detailed enlargement, in which it can be seen that the form-fit member 5 is arranged in the form-fit receptacle 3 in a manner biased by the spring force of the spring device 10. Furthermore, an optional switching sleeve 20 is shown, which is arranged coaxially with respect to the main axis of rotation 100 and which has a fastening collar 21 which engages over the inner circumference of the second disc 4 in a form-fitting manner so that the freewheel device 1 can be switched by a movement of the switching sleeve 20 in the axial direction. In the state shown, the freewheel device 1 is activated so that it can optionally assume the blocking state or the freewheel state. The freewheel device 1 is designed to be switchable by means of the switching sleeve 20.

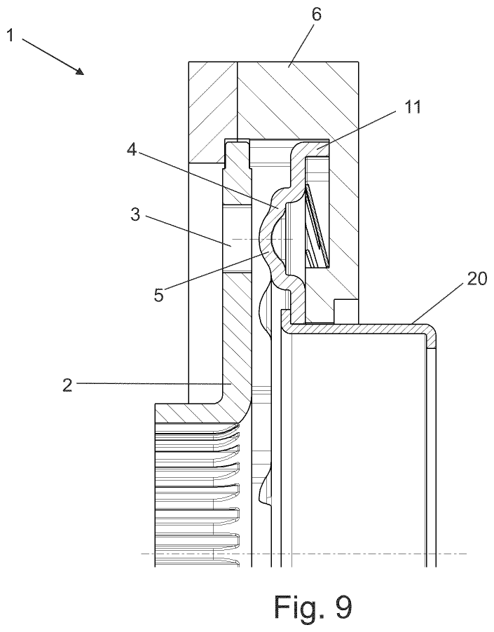

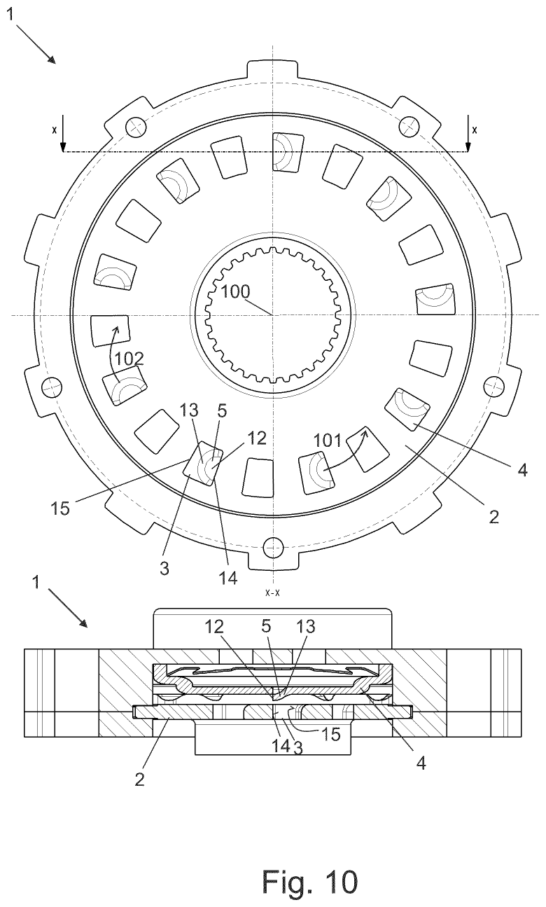

In FIG. 9, however, the switching sleeve 20 is arranged offset in the axial direction so that the form-fit members 5 are pulled out of the form-fit receptacles 3 and the discs 2, 4 can be rotated independently of one another and thus perform idling. The decoupled state is shown in FIG. 10 in the same representation as in FIG. 8.

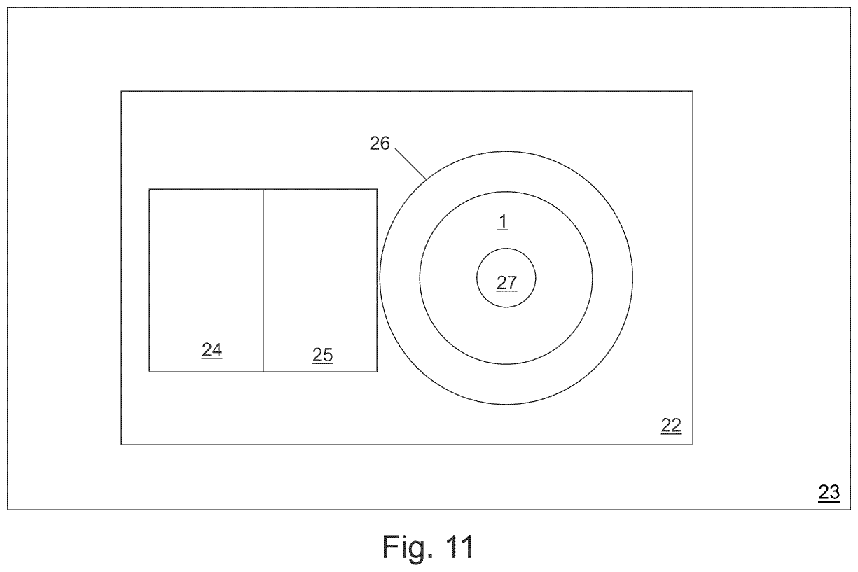

FIG. 11 shows a schematic block diagram of an electric drive 22 for a vehicle 23, in which the vehicle 23 is designed as a muscle-powered vehicle, for example as an electric bicycle. The electric drive 22 is realized in particular as a hub motor. The electric drive 22 has an electric motor 24 and a transmission 25 for converting the drive torque of the electric motor 24. Furthermore, the electric drive 22 has a drive gear 26, with the drive gear 26 outputting the converted drive torque of the electric motor 24.

The electric drive 22 has a pedal crankshaft 27, the pedal crankshaft 27 being arranged coaxially with respect to the drive gear 26. The freewheel device 1 is transmittingly arranged between the drive gear 26 and the pedal crankshaft 27. In particular, the pedal crankshaft 27 is connected to the first disc 2 and the drive gear 26 is connected to the second disc 4 in a rotationally fixed manner. For example, the drive gear 26 can be connected in a rotationally fixed manner to the second disc 4 via the housing 6. In particular, the drive gear 26 can be formed by the housing 6, in particular by a circumferential toothing system of the housing 6.

In this configuration, the converted drive torque can be transmitted from the electric motor 24 in the blocking state to the first disc 2 and thereby to the pedal crankshaft 27. The pedal crankshaft 27 is connected in a rotationally fixed manner to an output gear, such as a chain pinion, so that in this way the converted drive torque can be used to drive the vehicle 23. In the event that a rider of the vehicle 23 rotates the pedal crankshaft 27 faster than the drive gear 26, the freewheel device 1 is in a freewheel state and operates as an overrunning clutch. It is possible that the freewheel device 1 is designed as a non-switchable freewheel device 1, i.e. without a switching sleeve 20. In this case, a typical rattling noise occurs in the freewheel state when the form-fit members 5 repeatedly move briefly into the form-fit receptacles 3. Alternatively, the freewheel device 1 is designed as a switchable freewheel device 1, in which the first disc 2 and the second disc 4 can be rotationally decoupled by the switching sleeve 20 so that the vehicle 23 can be driven independently of the electric motor 24.

### REFERENCE NUMERALS

1 Freewheel device
2 First disc
3 Form-fit receptacles
4 Second disc
5 Form-fit members
6 Housing
7 Base part
8 Cover part
9 Fastening means
10 Spring device
11 Guide collar
12 Blocking section
13 Ramp section
14 Blocking contour
15 Ramp contour
16 Projections
17 Hub section
18 Projection contours
19 Projection receptacle
20 Switching sleeve
21 Fastening collar
22 Electric drive
23 Vehicle
24 Electric motor
25 Transmission
26 Drive gear
27 Pedal crankshaft
100 Main axis of rotation
101 Blocking direction
102 Freewheel direction

1. A freewheel device for an electric drive of a vehicle,
having a first disc, wherein the first disc comprises a plurality of form-fit receptacles,
having a second disc,
having a housing, wherein one of the discs is a rotationally fixed disc arranged in a rotationally fixed manner and the other disc is a rotatable disc arranged rotatably in the housing,
wherein:
the second disc has a plurality of rigid form-fit members, wherein the form-fit members can engage in the form-fit receptacles, wherein the form-fit members and the form-fit receptacles are in a blocking state in a blocking direction and are in a freewheel state in a freewheel direction,
and that the freewheel device has a spring device, wherein the spring device biases the rotationally fixed disc in the axial direction against the rotatable disc.

2. The freewheel device according to claim 1, wherein the form-fit members are formed integrally in the second disc.

3. The freewheel device according claim 1, wherein the second disc is designed as a shaped sheet-metal part and the form-fit members are designed as formed sections.

4. The freewheel device according to any one of the preceding claim 1, wherein:
the form-fit members each have a blocking section in the blocking direction and the form-fit receptacles each have a blocking contour, wherein the blocking section engages in the blocking contour in a form-fitting manner in the blocking direction; and
the form-fit members each have a ramp section in the freewheel direction and the form-fit receptacles each have a ramp contour, wherein the ramp section can slide on the ramp contour in the freewheel direction.

5. The freewheel device according to claim 1, wherein the rotatable disc is slidingly mounted in the housing.

6. The freewheel device according to claim 1, wherein the rotatable disc comprises a hub section for a shaft-hub connection.

7. The freewheel device according to claim 1, wherein the housing comprises an external toothing system.

8. The freewheel device according to claim 1, wherein the first disc is designed as a rotatable ramp disc and/or that the second disc is designed as a rotationally fixed pressure disc.

9. The freewheel device according to claim 1, further comprising a switching sleeve, wherein the switching sleeve is designed to displace the rotationally fixed disc in the axial direction.

10. An electric drive for a vehicle, comprising:
an electric motor for generating a drive torque,
a transmission for converting the drive torque,
a pedal crankshaft for introducing a pedal torque,
a drive gear, and
the freewheel device according to claim 1, wherein the drive gear is arranged coaxially with respect to the pedal crankshaft and is transmittingly connected to the pedal crankshaft via the freewheel device.

11. A freewheel device for a vehicle electric drive, comprising:
a housing;
a first disc arranged rotatably in the housing and comprising a plurality of form-fit receptacles;
a second disc arranged rotationally fixed in the housing and comprising a plurality of rigid form-fit members arranged to engage the form-fit receptacles; and
a spring device arranged to axially bias the second disc against the first disc, wherein:
the form-fit members and the form-fit receptacles are in a blocking state in a blocking direction; and
the form-fit members and the form-fit receptacles are in a freewheel state in a freewheel direction, opposite the blocking direction.

12. The freewheel device of claim 11, wherein the form-fit members are formed integrally in the second disc from a same piece of material.

13. The freewheel device of claim 12, wherein:
the second disc is a shaped sheet-metal part; and
the form-fit members are formed sections.

14. The freewheel device of claim 11, wherein:
the form-fit receptacles each have:
a blocking contour; and
a ramp contour; and
the form-fit members each have:
a blocking section engageable in the blocking contour in a form-fitting manner in the blocking direction; and
a ramp section slidable on the ramp contour in the freewheel direction.

15. The freewheel device of claim 11, wherein the first disc is slidingly mounted in the housing.

16. The freewheel device of claim 11, wherein the first disc comprises a hub section arranged for rotationally connecting to a shaft.

17. The freewheel device of claim 11, wherein the housing comprises an external toothing.

18. The freewheel device of claim 11, wherein:
the first disc is a rotatable ramp disc; and
the second disc is a rotationally fixed pressure disc.

19. The freewheel device of claim 11, further comprising a switching sleeve arranged to axially displace the second disc.
